(19) United States
(12) Patent Application Publication
(10) Pub. No.: US 2005/0257653 A1
(43) Pub. Date: Nov. 24, 2005

(54) Thermal severing scissors with a ceramic mount

(76) Inventors: Erich Weidmann, Wetzikon (CH); Armin Woodtli, Dubendorf (CH); Marcus Keulen, Unna (DE)

Correspondence Address: HARNESS, DICKEY & PIERCE, P.L.C., P.O. BOX 828, BLOOMFIELD HILLS, MI, 48303, US

(21) Appl. No.: 11/124,558

(22) Filed: May 5, 2005

(30) Foreign Application Priority Data
May 6, 2004 (EP) 04010780.7

(51) Int. Cl. B26D 7/10

(52) U.S. Cl. 83/171

(57) ABSTRACT

In order to sever planar textile structures, specifically for a severing and welding of edges of fabrics a heatable wire loop is located on a mount consists of a ceramic body through which two contact elements extend. At one end of the contact elements, projections lie arrested against rotation in a recess of the mount, at the other end nuts are arranged on a thread. In order to mount the apparatus, a mounting opening is foreseen which is adapted to receive a mounting rod, a clamping body is provided which can be tightened through a screw against the mounting rod wherewith detrimental tensile stresses in the ceramics body can be avoided to a large extent.

### CROSS-REFERENCE TO RELATED APPLICATIONS

This application claims the priority of European patent application No. 04 010 780.7, filed May 6, 2004, the disclosure of which is incorporated herein by reference in its entirety.

### FIELD OF THE INVENTION

The present invention relates to an apparatus for a severing of planar textile structures, a weaving loom with such an apparatus as well as an application of the apparatus in a weaving loom.

In the textile industry such apparatuses are known by the designation thermal severing scissors or edge melting apparatuses. They serve predominantly to sever planar textile structures, i.e. depending on the used method of fabrication, fabrics, knitted fabrics and other structures in their longitudinal direction and to simultaneously weld the edge or edges.

### DESCRIPTION OF THE PRIOR ART

Known severing scissors of this kind are described in the Swiss Patent Specification CH 680 227. They include a mount of metal in which two contact elements are located. A wire hoop is mounted to the contact elements and is heated electrically by a voltage applied to the contact elements. In order to prevent the contact elements from a shortening, they are electrically insulated from the mount by suitable insulation means.

For an economical application it is important that the severing scissors and their heating wires, respectively, can be exchanged and installed easily.

### SUMMARY OF THE INVENTION

Hence, it is an object of the present invention to provide severing scissors that can be exchanged and installed easily.

Hence, in a first aspect, the invention relates to an apparatus for a severing of planar textile structures, comprising a mount with two contact elements arranged in said mount, and a wire hoop connected to said contact elements, wherein said mount comprises a ceramics body in which both contact elements are retained.

Due to the use of a ceramics body separate insulation means for the contact elements are not necessary, which simplifies the assembly and allows a production of the apparatus using less parts. The ceramics body possesses, furthermore, the necessary temperature resistance so that it is not damaged by the heat of the wire hoop.

A mounting opening is advantageously foreseen in the ceramics body into which mounting opening a mounting rod can be inserted. The mounting rod may be, e.g., a rod arranged at a weaving loom onto which the severing scissors are to be mounted.

The mount includes, furthermore, advantageously a clamping device, e.g., in the form of a metal block with a hole and an arresting device, e.g., in the form of a screw. These are designed in such a manner that a force can be exerted onto the clamping device by the arresting device wherewith the clamping device presses the mounting rod inserted into the mounting opening against the edge of the mounting opening and clamps it accordingly. For this task for instance a screw can be foreseen which is supported against the ceramic body. When it is tightened, the clamping device is moved and clamps the mounting rod against the edges of the mounting opening. In such a design a thread in the ceramics body can be dispensed with and the ceramics is only burdened by pressure such that, even at an extremely firm tightening, no damage of the ceramics occurs.

In a further advantageous embodiment, the contact elements extend through the ceramics body. They are connected at a first side of the ceramics body to the hoop or to leads to the wire hoop and at a second side of the ceramics body to connectors for the power supply. Each mounting element forms at the second side a threaded bolt onto which a nut is threaded and tightened against the ceramics body. At the first side a non-rotationally-symmetric structure is foreseen, which is locked against rotation in a recess of the ceramics body so that during a tightening of the nut the contact element is held arrested by the mount, which facilitates the tightening of the nut.

The device is advantageously used for a severing of planar textile structures in a weaving loom. The invention relates also to this use and to a correspondingly equipped weaving loom.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 is a view of an embodiment of the invention;

FIG. 2 is a view of the apparatus of FIG. 1 from the side of the wire hoop;

FIG. 3 is a view of the apparatus from the lateral side with the ceramics body sectioned along line III-III of FIG. 2;

FIG. 4 is a view of the apparatus from the long side with the ceramics body and the clamping body sectioned along line IV-IV of FIG. 2; and

FIG. 5 is a second embodiment of the invention.

### DETAILED DESCRIPTION OF THE PREFERRED EMBODIMENTS

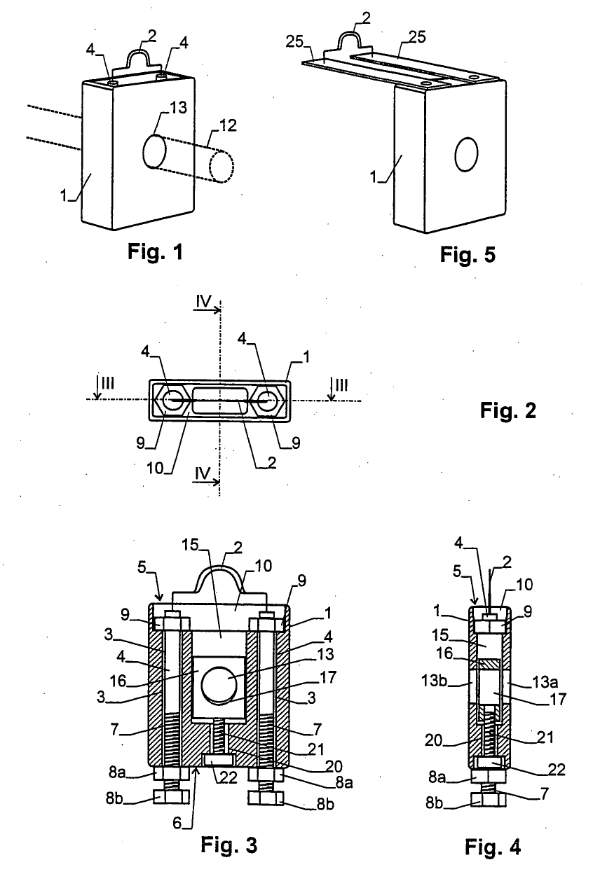

The apparatus according to FIGS. 1-4 comprises a mount 1 and a wire hoop 2.

The mount 1 exhibits an essentially cuboid contour. It is formed advantageously by an integral ceramics body. Two contact elements 4 extend in two parallel longitudinal holes 3 through the mount 1. Each contact element 4 consists of a cylinder shaped rod which in the present embodiment supports the respective ends of the wire hoop 2, and specifically at a first side 5 of the mount 1. At the opposite, second side 6 of the mount 1 the cylinder shaped rod of each contact element 4 is provided with a thread 7 onto which two nuts 8a, 8b are screwed. These nuts serve for a fastening of the contact element and form the connection for the power supply.

Each contact element 4 carries at the first side 5 of the mount 1 a structure or projection 9 of a, e.g., polygonal (or other, not rotationally-symmetric) cross-section. The projections 9 lie together in a recess 10 at the first side 5 of the ceramics body of the mount 1. The width of the recess 10 is selected in such a manner that it prevents a rotating of the projections 9 so that during the tightening of the nuts 8a, 8b the respective contact element 4 is locked against rotation. The projections 9 lie, furthermore, on the bottom of the recess 10 and secure the contact elements against the pulling force of the nuts 8a.

In order to mount the apparatus onto a supporting rod 12 (see FIG. 1) of a weaving loom, a mounting opening 13 is foreseen in the mount 1. The diameter of the mounting opening 13 is somewhat larger than the diameter of the mounting rod 12, so that the latter can be inserted into the mounting opening 13 without any large expenditure of force.

The mounting opening 13 is formed by two windows 13a, 13b which are located between the outer walls and an inner chamber 15 of the mount 1 (see FIG. 4). The inner chamber 15 is open towards the first side 5 of the mount 1 and receives displaceably a clamping body 16, which forms a clamping device. In the present embodiment the clamping body 16 is designed as a metal block with an essentially cuboid contour. A clamping opening 17 extends through the clamping body 16. The axis of the clamping opening 17 of clamping body 16 is oriented parallel to the connecting axis of the windows 13a, 13b. The diameter of the clamping opening 17 is advantageously somewhat larger than the one of the mounting openings 13 so that also in case of a slight misalignment of the clamping body 16 it is possible to insert the mounting rod 12 through the windows 13a, 13b and the claming opening 17.

A hole 20 extends from the second side 6 of the mount 1 into the inner chamber 15. A screw 21 is located in this hole 2 the thread of which engages an inner thread of the clamping body 16. The screw 21 forms a locking means by means of which the clamping body 16 or clamping device, respectively, may be moved relative to the ceramics body of the mount 1. When the screw 21 is tightened after the mounting rod 12 has been inserted, it pulls the clamping body 16 towards the second side 6 of the locking body so that the clamping body 16 presses the mounting rod 12 towards the edges of the mounting opening 13 and clamps the same. The head 22 of the screw 21 is, thereby, supported against the ceramics body and the ceramics body is loaded by pressure. Because ceramics absorb pressure forces better than pulling forces, a damaging of the ceramics body is prevented even when the screw 21 is tightened strongly.

As it can be seen clearly in FIG. 3, the clamping body 16 or clamping device, respectively, is located in a space saving manner between the contact elements 4 and can be moved by the screw 21 parallel to the longitudinal axes of the contact elements.

As can be seen in FIG. 4, the recess 10 widens step-wise or continuously towards the outside. By means of this a demolding of the ceramics body of the mount 1 is facilitated.

In the embodiment described so far, the screw 21 is used as a locking device for the clamping body 16 and engages a thread of the clamping body 16. Alternatively, it is also possible to provide the thread for the screw 21 on the ceramics body at the inner side of the hole 20, e.g., by setting a metal thread carrier into the ceramics body or by forming the thread in the ceramics body itself. In this case the tip of the screw presses against an outer surface of the clamping body 16. This solution leads, however, to somewhat higher tensile stresses in the ceramics body, for which reason the solution in accordance with the figures is advantageous.

In a further embodiment, which is illustrated in FIG. 5, the wire hoop 2 is not directly mounted onto the contact elements 4. Rather, the contact elements 4 are connected to two conductors 25. The wire hoop 2 is mounted to the ends of the conductors 25. The embodiment according to FIG. 5 can be, e.g., applied if there is no space for the mount at the location of the cut.

The apparatus according to the invention can be used for a severing of planar textile structures such as, e.g., fabrics or knitted fabrics of synthetic fibres. It is advantageously located at the edge of the fabric web of a weaving loom for a processing of the edge of the fabrics.

While there are shown and described presently advantageous embodiments of the invention, it is to be distinctly understood that the invention is not limited thereto but may be otherwise variously embodied and practised within the scope of the following claims.

1. An apparatus for a severing of planar textile structures comprising:
a mount with two contact elements arranged in said mount; and
a wire hoop connected to said contact elements,
wherein said mount comprises a ceramics body in which both contact elements are retained.

2. The apparatus of claim 1, wherein said ceramics body comprises a mounting opening for receiving a mounting rod, and wherein said mount comprises a clamping device and an arresting device, which arresting device is adapted to exert a force onto said clamping device, and wherein said clamping device is adapted to urge said mounting rod inserted in said mounting opening by exertion of the force towards an edge of said mounting opening.

3. The apparatus of claim 2 wherein said clamping device with said arresting device are moveable relative to said ceramics body.

4. The apparatus of claim 2 wherein said force is a pulling force.

5. The apparatus of claim 2 wherein said arresting device comprises a screw supported against said ceramics body.

6. The apparatus of claim 5 wherein a head of said screw is supported against said ceramics body.

7. The apparatus of claim 5 wherein said screw engages a thread arranged in said clamping device.

8. The apparatus of claim 2 wherein said clamping device comprises a clamping body having a clamping opening for receiving said mounting rod located in said mounting opening.

9. The apparatus of claim 8 wherein a diameter of said clamping opening is larger than a diameter of said mounting opening.

10. The apparatus of claim 8 wherein said clamping body is of metal.

11. The apparatus of claim 8 wherein said clamping body comprises a threading.

12. The apparatus of claim 2 wherein said clamping device is arranged displaceably in an inner chamber of said ceramics body, and wherein said mounting opening is formed by two windows in said ceramic body located at two opposite sides of said inner chamber.

13. The apparatus of claim 2 wherein said clamping device is located between said contact elements.

14. The apparatus of claim 13 wherein said clamping device is displaceable together with said arresting device parallel to said contact elements.

15. The apparatus of claim 1 wherein said contact elements extend through said ceramic body, are mounted at a first side of said ceramic body to said wire hoop or leads to said wire hoop and are mounted at a second side of said ceramic body to connectors for a power supply.

16. The apparatus of claim 15, wherein each contact element comprises a threading at the second side and a nut is screwed onto the threading and tightened against said ceramics body, and wherein each contact element comprises further a non-rotationally-symmetric structure which lies locked against rotation in a recess of said ceramics body, so that said contact element is held locked against rotation in the recess of said ceramics body during a tightening of said nut.

17. The apparatus of claim 16, wherein said recess is arranged on a first side of said ceramics body and widens step-wise or continuously towards the outside.

18. The apparatus of claim 16, wherein said structure is adapted to lock said contact element against a pulling force from said nut.

19. A use of the apparatus according to claim 1 for a severing of planar textile structures in a weaving loom.

20. A weaving loom comprising an apparatus according to claim 1.
